(19) United States
(12) Patent Application Publication
(10) Pub. No.: US 2013/0292620 A1
(43) Pub. Date: Nov. 7, 2013

(54) METHOD AND SYSTEM FOR APPLYING FORCE AGAINST A SOLID OBJECT USING A SWELLABLE SOL-GEL DERIVED MATERIAL

(71) Applicants: Paul L. Edmiston, Wooster, OH (US); Stephen R. Spoonamore, Wooster, OH (US)

(72) Inventors: Paul L. Edmiston, Wooster, OH (US); Stephen R. Spoonamore, Wooster, OH (US)

(73) Assignee: ABS MATERIALS, INC., Wooster, OH (US)

(21) Appl. No.: 13/814,241

(22) PCT Filed: Aug. 4, 2011
(86) PCT No.: PCT/US11/46634

§ 371 Date: May 9, 2013

(30) Foreign Application Priority Data
Aug. 4, 2010 (US) 61370486
Aug. 4, 2011 (US) PCT/US2011/046634

(51) Int. Cl. B66F 3/24

(52) U.S. Cl. CPC B66F 3/24
USPC 254/93 R

(57) ABSTRACT

Disclosed is a method and system for applying force against a solid object. A sol-gel derived sorbent material is placed against a solid object to be moved under conditions sufficient to contact the swellable sol-gel derived sorbent material with a sorbate and cause the sol-gel derived sorbent material to swell to at least I ½ times its volume in its unswollen slate to cause sol-gel derived sorbent material to expand and to apply force against the solid object.

### BACKGROUND OF THE INVENTION

1. Field of the Invention

The present invention relates generally to the chemical arts. More particularly, the invention relates to a method and system for applying force against a solid object.

2. Discussion of Related Art

There is a definite need for alternative methods and systems for applying force against a solid objects. For example, there is a definite need for methods and systems, particularly in emergency situations, that does not require battery power. Methods and systems capable of moving heavy objects, such as overturned vehicles, collapsed walls or bridges, and landslides with large boulders, as well as to lift armored vehicles damaged or overturned by IEDs, or lift bridge trusses or buildings after an earthquake are of especial importance There is a further definite need, particularly by police and armed forces, for methods and systems to pry open doors or windows that do not require explosives and that do not generate noise or a thermal imprint.

### SUMMARY OF THE INVENTION

Now in accordance with the invention there has been found a method and system that provides these and additional advantages. Disclosed is a method and system for applying force against a solid object. In some aspects, an expandable container, such as a telescoping cylinder, loaded with a swellable sol-gel derived sorbent material in its unswollen state is placed in contact with a solid object. A sorbate is introduced into the container under conditions sufficient to contact the swellable sol-gel derived sorbent material with the sorbate and cause the sol-gel derived sorbent material to swell to at least 1½ times, and in some embodiments, between about 2 to about 8 times, its volume in its unswollen state. The sol-gel derived sorbent material causes the container to expand and to apply force against the solid object.

In some other aspects, a swellable sol-gel derived sorbent material in its unswollen state is placed in an opening in a solid object. A sorbate is introduced into the opening of the object under conditions sufficient to contact the swellable sol-gel derived sorbent material with the sorbate, to cause the sol-gel derived sorbent material to swell a to at least 1½ times its volume in its unswollen state and to deform or fracture the solid object. In some embodiments, the sorbate is loaded into a balloon or bladder, before introducing the sorbate into the opening.

In some aspects, the sol-gel derived sorbent material is formed from

(a) about 5 to 100 mol percent of a first alkoxysilane precursor having the formula:

(RO)₃—Si—(CH₂)ₙ—Ar—(CH₂)ₘ₋—Si—(OR)₃

and

(b) from about 0 to about 95 mol percent of at least one second alkoxysilane precursor having the formula:

(RO)ₓ—(R₂)_{y}—Si—((R₁)—Si—(R₂)_{y}—(OR)ₓ)_{z}

where n and m are individually an integer from 1 to 8, Ar is a single-, fused-, or poly-aromatic ring, x is 2, 3 or 4, y is 0, 1 or 2 and z is 0 or 1, the total of x+y+z is 4, each R is independently hydrogen or a C1 to C6 alkyl, R1 is an alkyl or aromatic bridging group and each R2 is individually an organic group and each R is independently hydrogen or a C1 to C6 alkyl, such as methyl or ethyl. And in some aspects, the sol-gel derived sorbent material is formed from about 60 to about 40 mol percent (a) and from about 40 to about 60 mol percent (b).

In some aspects, the sorbate has a k_{ow} of less than about −0.3. And in some aspects, the sorbate is gasoline, diesel fuel or acetone.

In some aspects, the sorbate is introduced using a carrier gas. And in some aspects, the carrier gas is carbon dioxide or compressed air.

In some aspects, the sol-gel derived sorbent material generates a force greater than 80 N/g upon swelling. And in some aspects, the sol-gel derived sorbent material generates a force between about 80 N/g and about 120 N/g upon swelling.

Some aspects further include removing the sorbate from the swollen sol-gel derived sorbent material by heating the swollen sol-gel derived sorbent material to a temperature less than about 160 C.

Also disclosed is a system for applying a force against a solid object. The system includes an expandable container, a swellable sol-gel derived sorbent material in its unswollen stale loaded in the expandable container and a sorbent inlet, such as a limited access port or a glass frit, for introducing a sorbate into the expandable container.

In some aspects, the sol-gel derived sorbent material is swellable to at least 1½ times when contacted with a sorbate. And in some aspects, the sol-gel derived sorbent material is swellable to between about 2 to about 8 times its volume in its unswollen state when contacted with a sorbate.

In some aspects, the expandable container is a telescoping cylinder. And in some aspects, the telescoping cylinder has at least two annular telescoping elements, has first and second opposing ends, and has a surface disposed at at least one of the opposing ends.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1a is a cut-away, side plan view of an expandable container loaded with a sol-gel derived sorbent material in accordance with one embodiment of the present invention shown in a collapsed configuration.

FIG. 1b is a side plan view of the expandable container of FIG. 1a loaded with a sol-gel derived sorbent material in an expanded configuration.

### DETAILED DESCRIPTION OF THE PREFERRED EMBODIMENTS

Particular embodiments of the invention are described below in considerable detail for the purpose of illustrating its principles and operation. However, various modifications may be made, and the scope of the invention is not limited to the exemplary embodiments described below.

Unless otherwise described, all technical terms used herein have the same meaning as commonly understood by one of ordinary skill in the art to which the present invention pertains.

As used herein, the term “sorbate” means an organic compound that is taken up by the sol-gel derived sorbent material by adsorption, absorption, or a combination thereof. The method and system is of particular use with sorbates having a k_{ow} of less than about −0.3.

As used herein, “nanoparticle” means a particle sized between about 0.05 and about 50 nanometers in one dimension.

In accordance with the invention, there has been discovered a novel method and system for applying force against a solid object using a swellable sol-gel derived sorbent material. In some embodiments, the sol-gel derived sorbent material is formed from about 5 to 100 mol percent, and in some embodiments from about 60 to about 40 mol percent, of a first alkoxysilane precursor having the formula:

(RO)₃—Si—(CH₂)ₙ—Ar—(CH₂)ₘ₋—Si—(OR)₃ (1)

where n and m are individually an integer from 1 to 8, Ar is a single-, fused-, or poly-aromatic ring, and each R is independently hydrogen or a C₁ to C₆ alkyl, such as methyl or ethyl and from about 95 to about 0 mol percent, and in some embodiments from about 40 to about 60 mol percent, of at least one second alkoxysilane precursor having the formula:

(RO)ₓ—(R₂)_{y}—Si—((R₁)—Si—(R₂)_{y}—(OR)ₓ)_{z} (2)

where x is 2, 3 or 4, y is 0, 1 or 2 and z is 0 or 1, where the total of x+y+z is 4, and where each R is independently an alkyl group as described above, R₁ is an alkyl or aromatic bridging group and each R₂ is individually an organic group.

Exemplary first precursors include, without limitation, bis(trialkoxysilylalkyl)benzenes, such as 1,4-bis(trimethoxysilylmethyl)benzene (BTB), bis(triethoxysilylethyl)benzene (BTEB), and mixtures thereof, with bis(triethoxysilylethyl)benzene being preferred.

In some embodiments of the second precursor, each R₂ is independently an aliphatic or non-aliphatic hydrocarbon containing up to about 30 carbons, with or without one or more hetero atoms (e.g., sulfur, oxygen, nitrogen, phosphorus, and halogen atoms) or hetero atom containing moieties, including straight-chain hydrocarbons, branched-chain hydrocarbons, cyclic hydrocarbons, and aromatic hydrocarbons is an unsubstituted or substituted hydrocarbon. In some aspects, the hydrocarbons include alkyl hydrocarbons, such as C₁-C₃ alkyls, and aromatic hydrocarbons, such as phenyl, and aromatic hydrocarbons substituted with heteroatom containing moieties, such —OH, —SH, —NH₂, and aromatic amines, such as pyridine.

Representative substituents for R₂ include primary amines, such as aminopropyl, secondary amines, such as bis(triethoxysilylpropyl)amine, tertiary amines, thiols, such as mercaptopropyl, isocyanates, such as isocyanopropyl, carbamates, such as propylbenzylcarbamate, alcohols, alkenes, pyridine, halogens. halogenated hydrocarbons or combinations thereof.

Exemplary second precursors include, without limitation, 1,6-bis(trimethoxysilyl)hexane, 1,4-bis(trimethoxysilyl)benzene methyltrimethoxysilane, phenyltrimethoxysilane, with phenyltrimethoxysilane being preferred.

Sol-gel derived sorbent materials of the present invention are prepared from a reaction medium containing at least one first alkoxysilane precursor and, in some embodiments, at least one second alkoxysilane alkoxysilane precursor, under acid or base sol-gel conditions, preferably base sol-gel conditions. The reaction medium is formed with any suitable solvent. Representative solvents for use with the base catalysts include, without limitation, tetrahydrofuran (THF), acetone, dichloromethane/THF mixtures containing at least 15% by vol. THF, and THF/acetonitrile mixtures containing at least 50% by vol. THF. Of these exemplary solvents, THF is preferred.

The alkoxysilane precursor mixture is preferably present in the reaction medium at between about 0.25M and about 1M, more preferably between about 0.4M and about 0.8M, most preferably about 0.5 M.

A catalytic solution comprising a stoichiometric amount of water and a catalyst is rapidly added to the reaction medium to catalyze the hydrolysis and condensation of the alkoxysilane precursors. Conditions for sol-gel reactions are well-known in the art and include the use of acid or base catalysts Preferred conditions are those that use a base catalyst. Exemplary base catalysts include, without limitation, tetrabutyl ammonium fluoride (TBAF), 1,5-diazabicyclo[4.3.0]non-5-ene (DBN), and alkylamines (e.g., propyl amine), of which TBAF is preferred.

As noted above, acid catalysts can be used to form swellable sol-gels, although acid catalysts are less preferred. Exemplary acid catalysts include, without limitation, any strong acid such as hydrochloric acid, phosphoric acid, sulfuric acid and the like.

After gellation, the material is preferably aged for an amount of time suitable to induce syneresis, which is the shrinkage of the gel that accompanies solvent evaporation. The aging drives off much, but not necessarily all of the solvent. While aging times vary depending upon the catalyst and solvent used to form the gel, aging is typically carried out for about 15 minutes up to about 7 days, preferably from about 1 hour up to about 4 days. Aging is carried out at room temperature or elevated temperature (i.e., from about 18 C up to about 60 C), either in open atmosphere, under reduced pressure, or in a container or oven.

Solvent and catalyst extraction (i.e., rinsing) is carried out during or after the aging process. Preferred materials for extraction include, without limitation, any organic solvent of medium polarity, including, without limitation, THF, acetone, ethanol, and acetonitrile, either alone or in combination.

After rinsing, the sol-gel derived sorbent material is characterized by the presence of residual silanols. In some embodiments, the silanol groups are derivatized using any reagent that includes both one or more silanol-reactive groups and one or more non-reactive alkyl groups. The derivatization process results in the end-capping of the silanol-terminated polymers present within the sol-gel derivative sorbent material with alkylsiloxy groups having the formula:

—(O)ₓ—Si—R₄₋ₓ (3)

where each R₂ is independently an organic group as described above and x is an integer from 1 to 3.

One suitable class of derivatization reagents includes halosilane reagents that contain at least one halogen group and at least one alkyl group R, as described above. The halogen group can be any halogen, preferably Cl, Fl, I, or Br. Preferred halosilanes or dihalosilanes include, without limitation, chlorosilanes, dichlorosilanes, fluorosilanes, difluorosilanes, bromosilanes, dibromosilanes, iodosilanes, and di-iodosilanes. Exemplary halosilanes suitable for use as derivatization reagents include, without limitation, cynanoproyldimethyl-chlorosilane, phenyldimethylchlorosilane, chloromethyldimethylchlorosilane, (trideca-fluoro-1,1,2,2-tetrahydro-octyl)dimethylchlorosilane, n-octyldimethylchlorosilane, and n-octadecyldimethylchlorosilane. The structures of these exemplary reagents are shown in FIG. 2.

Another suitable class of derivatization reagents includes silazanes or disilazanes. Any silazane with at least one reactive group X and at least one alkyl group R, as described above can be used. A preferred disilazane is hexamethyldisilazane.

The sol-gel derived sorbent material is preferably rinsed in any of the rinsing agents described above, and then dried. Drying can be carried out under any suitable conditions, but preferably in an oven, e.g., for about 2 hours at about 60 C to produce the porous, swellable, sol-gel derived sorbent material.

The sol-gel derived sorbent materials can be used in any suitable form, including in powder form. Powdered forms of the sol-gel derived sorbent materials are characterized by a high surface area, for example, in the range of about 800 m²/g, which allows for rapid and effective uptake of the sorbate. Furthermore, powders can be packed or injected into tight spaces. Depending upon the manner in which grinding of the sol-gel derived sorbent materials is carried out to obtain the powdered form, the particle sizes may vary widely. Preferred powdered forms will have a high surface area (e.g., about 800 m²/g) and an average particle size that is less than about 250 μm, for example, between about 50 to about 250 μm.

In some aspects, the materials contain a plurality of flexibly tethered and interconnected organosiloxane particles having diameters on the nanometer scale. The organosiloxane nanoparticles form a porous matrix defined by a plurality of aromatically cross-linked organosiloxanes that create a porous structure.

And in some aspects, the resulting sol-gel derived sorbent materials are hydrophobic, resistant to absorbing water, and swellable to at least 1.5 times its volume. Preferred sol-gel derived sorbent materials are swellable to at least two times their original volume, more preferably at least five times their original volume, most preferably up to about eight times their original volume.

Without being bound by theory, it is believed that swelling is derived from the morphology of the interconnected organosilica particles that are cross-linked during the gel state to yield a nanoporous material or polymeric matrix. Upon drying the gel, tensile forces are generated by capillary-induced collapse of the polymeric matrix. This stored energy is released as the matrix relaxes to an expanded state when a sorbate disrupts the inter-particle interactions holding the dried material in the collapsed state. In some aspects, uptake of the sorbate generates forces greater than 80 N/g, typically in the range of 80-120 N/g or more, as the swellable sol-gel sorbent materials rapidly expand, that sol-gel derived sorbent material can lift an object at least 20,000 times its own weight. And is some aspects, the swelling is completely reversible as the sorbed sorbates are removed by evaporation or rinse/drying.

In accordance with one aspect of the inventive method and system, the swellable sol-gel derived sorbent material, in its unswollen state, is placed in contact with a solid object. The sol-gel derived sorbent material is contacted with a sorbate under conditions sufficient to cause the sol-gel derived sorbent material to swell and apply a force against the solid object.

The method and system is of particular use with sorbates having a k_{ow} of less than about −0.3. Representative sorbates include, without limitation, gasoline, diesel fuel or acetone.

In some aspects, the sol-gel derived sorbent material is caused to swell to at least 1½ limes its volume in its unswollen state when contacted with the sorbate and in some further aspects, the sol-gel derived sorbent material is caused to swell between about 2 to about 8 times its volume in its unswollen state when contacted with the sorbate. In some aspects, the sol-gel derived sorbent materials generate a force greater than 80 N/g upon swelling, while in some further aspects, the sol-gel derived sorbent material generates a force of between about 80 and about 120 N/g or more.

It is a distinct advantage of the invention that the swellable sol-gel derived sorbent material can be contacted with the sorbate at ambient temperature and pressure. The amount of sorbate used to contact the swellable sol-gel derived sorbent material will vary with the particular swellable sol-gel derived sorbent material, the particular sorbate and the amount of expansion desired and will be readily determinable by one skilled in the art without undue experimentation. Typically, the volume of sorbate is from one to about seven times the volume of the sol-gel derived sorbent material.

In some embodiments, a carrier gas containing the sorbate is used to contact the sol-gel derived sorbent material with the sorbate. Representative carrier gases include, but are not limited to, carbon dioxide or compressed air.

In some aspects, an expandable container loaded with the swellable sol-gel derived sorbent material in its unswollen

sol-gel derived sorbent material with the sorbate, to cause the sol-gel derived sorbent material to swell a to at least 1½ times its volume in its unswollen state so as to expand the container and apply force against the solid object.

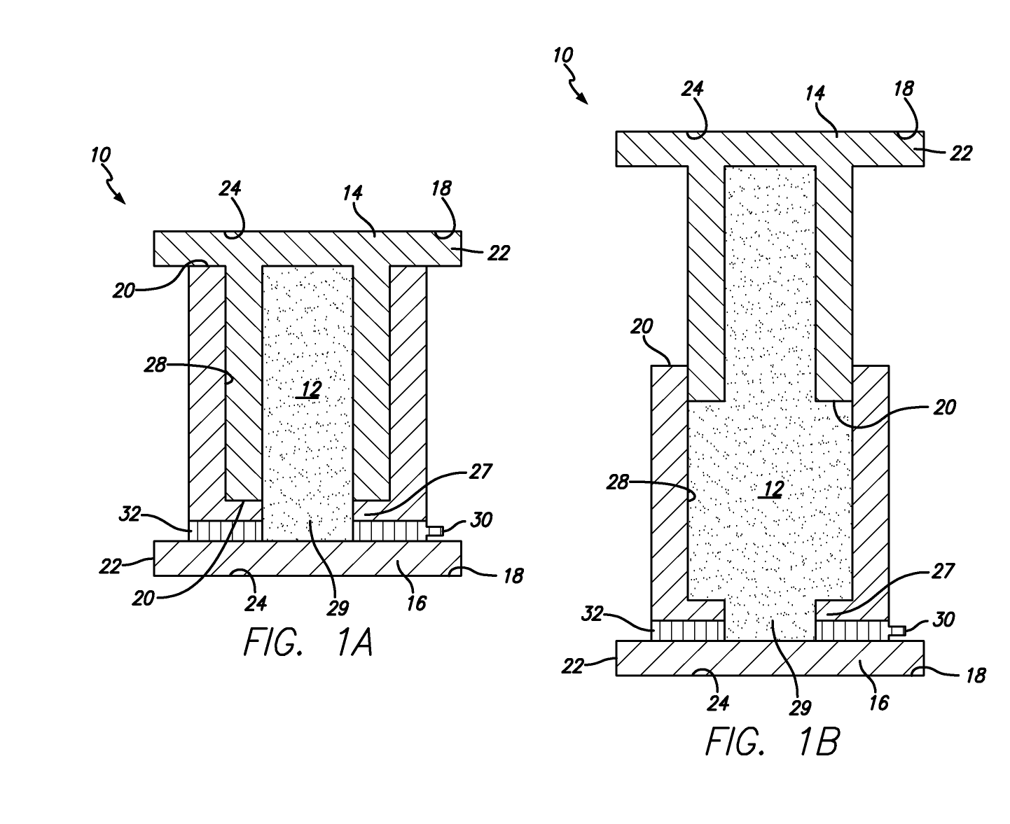

In some aspects, the expandable container is a telescoping cylinder, flexible bladder or ball. Shown in FIG. 1a is a cut away, side plan view of a telescoping cylinder 10 loaded with a sol-gel derived sorbent material 12 in accordance with one embodiment of the present invention in a collapsed configuration. Shown in FIG. 1b is a cut away, side plan view of telescoping cylinder loaded with a sol-gel derived sorbent material in an expanded configuration.

The container can be made of any suitable material, including without limitation, metals, such as stainless steel and aluminum, and engineering plastics, such at polycarbonates and polyamides. For simplicity, the telescoping cylinder 10 shown in FIG. 1 contains only an annular inner telescoping element 14 and an annular outer telescoping element 16. It can be appreciated, however, that the telescoping cylinder can contain a greater number of annular elements if desired. The telescoping elements each have a contact end 18 and an opposing non-contact end 20, the contact end adapted to engage the surface of a solid object (not shown). The telescoping elements can have any suitable cross section, including without limitation that of a circle, an oval, a polygon, such as a triangle, a square, a rectangle or the like.

In the embodiment shown in FIG. 1A, contact flanges 22 having contact surfaces 24 are formed on the contact ends 18 of telescoping elements 14 and 16 The contact surfaces increase the surface area of the telescoping cylinder in contact with the object to which force is to be applied, so as to improve the contact. In some embodiments, the contact surface is roughened or contains barbs or spikes or the like (not shown) to further improve contact. And in some embodiments, at least one of the flanges is removably attached, such as threadably attached, to a telescoping element, to facilitate the loading and the unloading of the sol-gel derived sorbent material 12.

In the embodiment shown in FIG. 1A, an annular stop 27 is disposed on the inner surface 28 of the outer telescoping element 16 near its contact end 18. The annular stop is positioned to limit the movement of the inner element 14 when the container is in its collapsed configuration and to define a sorbate entry zone 29 between the contact end of the outer element and the non contact end 20 of the inner element. A sorbate inlet 30 is disposed in the outer element to provide access to the sorbate entry zone. Suitable access ports include, without limitation, a limited access port or a glass frit. In those embodiments where the sorbate is introduced using a carrier gas, a gas permeable, sorbate impermeable vent 32 is also disposed in the outer element in fluid communication with the sorbate entry zone.

In some embodiments, the telescoping cylinder is loaded with from about 100 to about 1000 g of sol-gel derived sorbent material. In such aspects, the system can be used to generate at least 2-20 tons of lifting force and move heavy objects, including overturned vehicles, collapsed walls or bridges, and landslides with large boulders. This lifting force is sufficient to lift armored vehicles damaged or overturned by IEDs, lift bridge truss or buildings after an earthquake.

In some aspects, the telescoping cylinder is loaded with from about 10 to about 200 g of sol-gel derived sorbent material. In such aspects, the system can be used by police or armed forces to pry open doors or windows with no explosives, no noise generated by the system itself and no thermal imprint. Because, the expansion is a product of a nano-molecular interface, it gives no thermal signature to IR or other night vision surveillance devices.

In another aspect, the sol-gel derived sorbent material is placed in an opening, such as a crack, fissure, or hole, in the solid material and upon swelling causes the solid material to fracture or deform. In some embodiments, the sol-gel derived sorbent material is directly packed or injected into the opening. In alternative embodiments, the sol-gel derived sorbent material is first loaded in a flexible bladder or ball and then placed in the opening.

It is a further definite advantage of the invention that the swelling process is reversible. Thus, in some embodiments, the sorbate is removed, such as evaporated by heating up to about 160 C, to cause the system to return to its initial collapsed configuration.

From the above described description of the invention, those skilled in the art will perceive improvements, changes and modifications. Such improvements, changes and modifications are within the skill of the art and are intended to be covered by the appended claims.

1. A method for applying force against a solid object comprising:
placing an expandable container with a swellable sol-gel derived sorbent material in its unswollen state in contact with a solid object and
introducing a sorbate into the container under conditions sufficient to contact the swellable sol-gel derived sorbent material with the sorbate, to cause the sol-gel derived sorbent material to swell to at least 1½ times its volume in its unswollen state, to expand the container and to apply force against the solid object.

2. The method of claim 1 wherein the expandable container is a telescoping cylinder.

3. A method for applying force against a solid object comprising:
placing a swellable sol-gel derived sorbent material in its unswollen state in an opening in a solid object and
introducing a sorbate into the opening under conditions sufficient to contact the swellable sol-gel derived material with the sorbate, to cause the sol-gel derived sorbent material to swell to a least 1½ times its volume in its unswollen state and to deform or fracture the solid object.

4. The method of claim 3 further comprising loading the sorbate into a balloon bladder, before introducing the sorbate into the opening.

5. The method of claim 1 wherein the sol-gel derived sorbent material is formed from
(a) about 5 to 100 mol percent of a first alkoxysilane precursor having the formula:
(RO)₃—Si—(CH₂)ₙ—Ar—(CH₂)ₘ₋—Si—(OR)₃
(b) from about 0 to about 95 mol percent of at least one second alkoxysilane precursor having the formula:
(RO)ₓ—(R₂)_{y}—Si—((R₁)—Si—(R₂)_{y}—(OR)ₓ)_{z}
where n and m are individually an integer from 1 to 8, Ar is a single-, fused-, or poly-aromatic ring, x is 2, 3 or 4, y is 0, 1 or 2 and z is 0 or 1, the total of x+y+z is 4, each R is independently hydrogen or a C1 to C6 alkyl, R1 is an alkyl or aromatic bridging group and each R2 is individually an organic group and each R is independently hydrogen or a C1 to C6 alkyl, such as methyl or ethyl.

6. The method of claim 5 wherein the sol gel derived sorbent material is formed from about 60 to about 40 mol percent (a) and from about 40 to about 60 mol percent (b).

7. The method of claim 1 wherein the sorbate has a k_{ow} of less than about −0.3.

8. The method of claim 1 wherein the sorbate is gasoline, diesel feel or acetone.

9. The method of claim 1 where the sorbate is introduced using a carrier gas.

10. The method of claim 9 wherein the carrier gas is carbon dioxide or compressed air.

11. The method of claim 1 wherein the sol-gel derived sorbent material swells to between about 2 to about 8 times its volume in its unswollen state when contacted with the sorbate.

12. The method of claim 1 wherein the sol-gel derived sorbent material generates a force greater than 80 N/g upon swelling.

13. The method of claim 12 wherein the sol-gel derived sorbent material generates a force between about 80 N/g and about 120 N/g upon swelling.

14. The method of claim 1 further comprising removing the sorbate from the swollen sol-gel material by heating the swollen sol-gel derived sorbent material to a temperature less than about 160 C.

15. A system for applying a force against a solid object comprising
an expandable container:
a swellable sol-gel derived material in its unswollen state and loaded in the expandable container and
a sorbent inlet for introducing a sorbate into the expandable container.

16. The system of claim 15 wherein the sol-gel derived sorbent material is swellable to a at least 1½ times its volume in its unswollen state when contracted with a sorbate.

17. The system of claim 16 wherein the sol gel derived sorbent material is swellable to from about 2 to about 8 times its volume in its unswollen state when contacted with a sorbate.

18. The system of claims 15-17 wherein the sol-gel derived sorbent material is formed from
(a) about 5 to 100 mol percent of a first alkoxysilane precursor having the formula:
(RO)₃—Si—(CH₂)ₙ—Ar—(CH₂)ₘ₋—Si—(OR)₃
and
(b) from about 0 to about 95 mol percent of at least one second alkoxysilane precursor having the formula:
(RO)ₓ—(R₂)_{y}—Si—((R₁)—Si—(R₂)_{y}—(OR)ₓ)_{z}
where n and m are individually an integer from 1 to 8, Ar is a single-, fused-, or poly-aromatic ring, x is 2, 3 or 4, y is 0, 1 or 2 and z is 0 or 1, the total of x+y+z is 4, each R is independently hydrogen or a C1 to C6 alkyl, R1 is an alkyl or aromatic bridging group and each R2 is individually an organic group and each R is independently hydrogen or a C1 to C6 alkyl, such as methyl or ethyl.

19. The system of claim 18 wherein the sol-gel derived sorbent material is formed from about 60 to 40 mol percent (a) and from about 40 to about 60 mol percent (b).

20. The system of claims 15 through 19 wherein the expandable container is a telescoping cylinder.

21. The system of claim 20 wherein the telescoping cylinder comprises:
at least two annular telescoping elements having first and second opposing ends,
a support surface disposed at the first end and a second support surface disposed at the second end.

22. The system of claim 15 wherein the sorbate inlet port is a limited access port or a glass frit.
